(19) United States
(12) Patent Application Publication
(10) Pub. No.: US 2026/0029017 A1
(43) Pub. Date: Jan. 29, 2026

(54) DUST BOOT AND BALL JOINT STRUCTURE

(71) Applicant: SHIH HSIANG AUTO PARTS CO., LTD., Taipei City (TW)

(72) Inventors: Che-Hung CHOU, Taipei City (TW); Jung-Yin LAI, Taipei City (TW)

(21) Appl. No.: 19/224,928

(22) Filed: Jun. 2, 2025

(30) Foreign Application Priority Data
Jul. 23, 2024 (TW) 113127438

(51) Int. Cl. F16C 11/06

(52) U.S. Cl. CPC F16C 11/0642; F16C 11/068

(57) ABSTRACT

A dust boot includes a covering body, an inner bundling body, an inner bundling ring, a channel and an oil draining hole. The covering body includes a covering space, a first annular edge and a second annular edge. The inner bundling body is adjacent to the first annular edge, the inner bundling body protrudes radially toward the covering space. The inner bundling ring is covered by the inner bundling body, the inner bundling ring includes a ring portion and a bundle portion. The bundle portion protrudes downwardly along an axis from an inner edge of the ring portion. The channel communicates with the covering space. The oil draining hole passes through the covering body and communicates with the channel, wherein the oil draining hole allows an oil to drain from the covering space.

### RELATED APPLICATIONS

This application claims priority to Taiwan Application Serial Number 113127438, filed Jul. 23, 2024, which is herein incorporated by reference.

### BACKGROUND

### Technical Field

The present disclosure relates to a dust boot and a ball joint structure. More particularly, the present disclosure relates to a dust boot and a ball joint structure capable of draining oil.

### Description of Related Art

In the automotive industry, to extend the service life of various automotive parts, the dust boots are set at the joints between the automotive parts to prevent the moisture and dirt the by relevant industries, and the dust boots can be injected with oil to lubricate the joints.

A conventional dust boots can be provided with a channel and an oil draining hole on its covering body, allowing old lubricant to be drained through the channel and oil draining hole. This prevents the degradation of the lubricant due to aging, thereby maintaining its lubricating performance and avoiding increased wear at the joints between automotive parts, which would otherwise reduce the service life of the automotive parts.

However, providing a channel and an oil draining hole on the covering body may compromise the airtightness of the dust boots, allowing moisture or dirt to enter. Furthermore, when designing dust boots for different models, the shape and position of the channel and oil draining hole must be individually evaluated due to variations in size and appearance.

In view of this, how to improve the structure of the dust boots so that the channel and oil draining hole are less susceptible to deformation from compression, while still reliably providing an oil discharge function, has become a goal pursued by relevant industries.

### SUMMARY

According to one aspect of the present disclosure, a dust boot includes a covering body, an inner bundling body, an inner bundling ring, a channel and an oil draining hole. The covering body includes a covering space, a first annular edge and a second annular edge. The second annular edge is opposite to the first annular edge. A diameter of the second annular edge is greater than a diameter of the first annular edge. The inner bundling body is disposed on the covering body and is adjacent to the first annular edge, the inner bundling body protrudes radially toward the covering space. The inner bundling ring is located inside the inner bundling body and is covered by the inner bundling body, the inner bundling ring includes a ring portion and a bundle portion. The bundle portion protrudes downwardly along an axis from an inner edge of the ring portion. The channel is disposed in the inner bundling body and communicates with the covering space, the channel is located in a bottom of the ring portion and an outside of the bundle portion. The oil draining hole passes through the covering body and communicates with the channel. The oil draining hole allows an oil to drain from the covering space.

According to another aspect of the present disclosure, a ball joint structure includes a ball socket, a ball pin and a dust boot. The ball socket includes a ball socket space. The ball pin includes a spherical portion and a shafting portion. The spherical portion is connected to the shafting portion, and when the ball pin is inserted into the ball socket, the spherical portion is accommodated in the ball socket space. The dust boot is encases on the shafting portion and an upper end of the ball socket, the dust boot includes a covering body, an inner bundling body, an inner bundling ring, a channel and an oil draining hole. The covering body includes a covering space, a first annular edge and a second annular edge. The shafting portion is disposed through the covering space, and the upper end of the ball socket is accommodated in the covering space, the second annular edge is opposite to the first annular edge, a diameter of the second annular edge is greater than a diameter of the first annular edge. The inner bundling body is disposed on the covering body, adjacent to the first annular edge and abuts against the shafting portion, the inner bundling body protrudes radially toward the covering space. The inner bundling ring is located inside the inner bundling body and covered by the inner bundling body, the inner bundling ring includes a ring portion and a bundle portion. The bundle portion protrudes downwardly along an axis from an inner edge of the ring portion. The channel is disposed in the inner bundling body and communicates with the covering space, the channel is located in a bottom of the ring portion and an outside of the bundle portion. The oil draining hole passes through the covering body and communicates with the channel. The oil draining hole allows an oil to drain from the covering space.

### BRIEF DESCRIPTION OF THE DRAWINGS

The present disclosure can be more fully understood by reading the following detailed description of the embodiment, with reference made to the accompanying drawings as follows:

FIG. 1 is a three-dimensional view of a dust boot of the 1st embodiment of the present disclosure.

FIG. 2 is a cross-sectional view of the dust boot of the 1st embodiment in FIG. 1.

FIG. 3 is an enlarged view of the portion 3 of FIG. 2.

FIG. 4 is a three-dimensional view of a dust boot of the 2nd embodiment of the present disclosure.

FIG. 5 is a three-dimensional view of a ball joint structure of the 3rd embodiment of the present disclosure.

FIG. 6 is an exploded view of the ball joint structure of the 3rd embodiment in FIG. 5.

### DETAILED DESCRIPTION

The embodiment will be described with the drawings. For clarity, some practical details will be described below. However, it should be noted that the present disclosure should not be limited by the practical details, that is, in some embodiment, the practical details is unnecessary. In addition, for simplifying the drawings, some conventional structures and elements will be simply illustrated, and repeated elements may be represented by the same labels.

In addition, the terms first, second, third, etc. are used herein to describe various elements or components, these elements or components should not be limited by these terms. Consequently, a first element or component discussed below could be termed a second element or component.

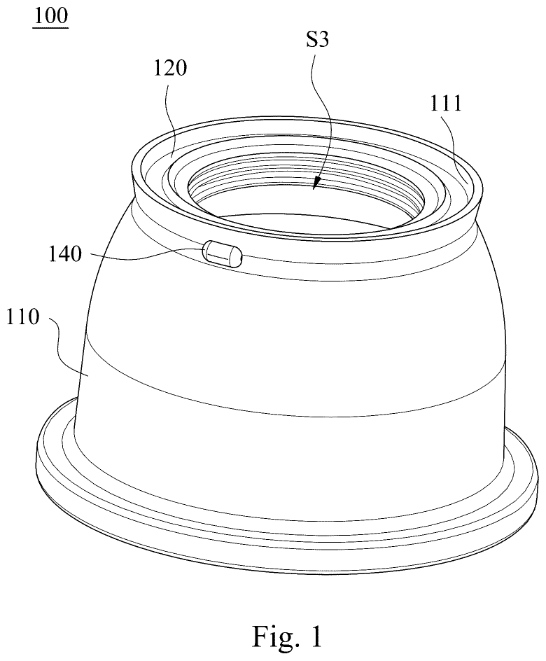

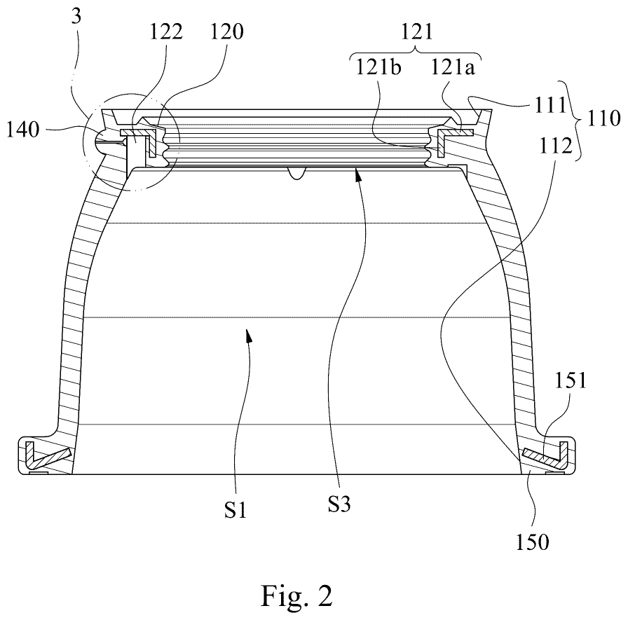

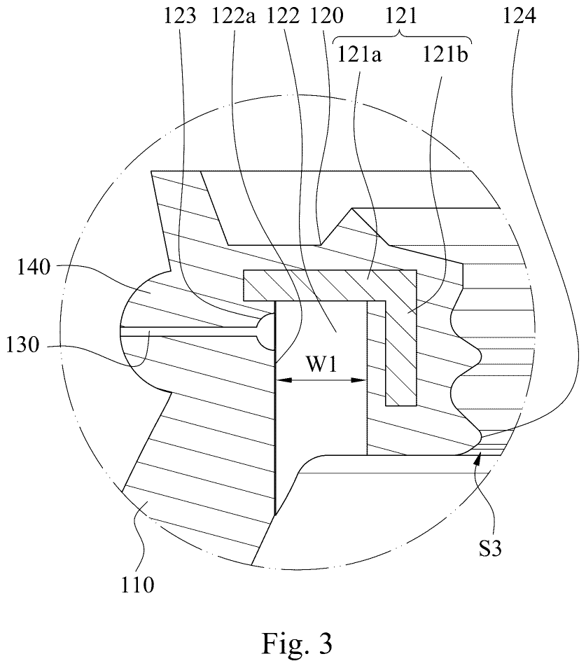

FIG. 1 is a three-dimensional view of a dust boot 100 of the 1st embodiment of the present disclosure. FIG. 2 is a cross-sectional view of the dust boot 100 of the 1st embodiment in FIG. 1. According to FIG. 1 and FIG. 2, the dust boot 100 includes a covering body 110, an inner bundling body 120, an inner bundling ring 121, a channel 122 and an oil draining hole 130 (as shown in FIG. 3).

The covering body 110 includes a covering space S1, a first annular edge 111 and a second annular edge 112. The second annular edge 112 is opposite to the first annular edge 111, a diameter of the second annular edge 112 is greater than a diameter of the first annular edge 111. The inner bundling body 120 is disposed on the covering body 110 and is adjacent to the first annular edge 111, the inner bundling body 120 protrudes radially toward the covering space S1. The inner bundling ring 121 is located inside the inner bundling body 120 and is covered by the inner bundling body 120, the inner bundling ring 121 includes a ring portion 121a and a bundle portion 121b. The bundle portion 121b protrudes downwardly along an axis from an inner edge of the ring portion 121a. The channel 122 is disposed in the inner bundling body 120 and communicates with the covering space S1, the channel 122 is located in a bottom of the ring portion 121a and an outside of the bundle portion 121b. The oil draining hole 130 passes through the covering body 110 and communicates with the channel 122, wherein the oil draining hole 130 allows an oil (not shown) to drain from the covering space S1.

Therefore, the channel 122 adjacent to the inner bundling ring 121 can prevent the oil draining hole 130 from being easily squeezed, and it is favorable for stably providing the oil draining function.

The covering body 110 is roughly bell-shaped, so that the diameter of the first annular edge 111 is smaller than the diameter of the second annular edge 112. The inner bundling body 120 is roughly ring-shaped to form an opening S3, and the inner bundling body 120 protrudes radially toward the covering space S1 from an inner surface of the covering body 110 adjacent to the opening S3. The inner bundling ring 121 is made of a hard material, such as steel, copper, etc. The inner bundling ring 121 is disposed in the inner bundling body 120 to prevent the opening S3 of the covering body 110 from being deformed. In detail, the inner bundling ring 121 includes the ring portion 121a in circular ring shape, and the bundle portion 121b extends along the axial, so that any cross section of the inner bundling ring 121 is L-shaped.

FIG. 3 is an enlarged view of the portion 3 of FIG. 2. According to FIG. 1, FIG. 2 and FIG. 3, the channel 122 is a cylindrical groove, the channel 122 extends along the axial from the inner bundling body 120 toward a surface of the second annular edge 112 to the bottom of the ring portion 121a.

The oil can contact the ring portion 121a through the channel 122, and there is a distance between the channel 122 and the bundle portion 121b, so that the channel 122 does not extend to the bundle portion 121b. In other embodiments, the channel can maintain a distance from the ring portion so that the channel does not extend to the ring portion, or the channel can also extend radially inward, so that the channel extends to the bundle portion, and the oil contacts the bundle portion through the channel, but the present disclosure is not limited thereto. A channel width W1 of the channel 122 is between 1 mm and 10 mm, and it is favorable for helping the oil to enter the channel 122 from the covering space S1.

The inner bundling body 120 can further include an inner groove 123, the inner groove 123 is recessed in a channel wall 122a of the channel 122, and the inner groove 123 communicates with the channel 122. The oil draining hole 130 passes through the inner groove 123. Specifically, the inner groove 123 is a hemispherical groove, and the inner groove 123 is recessed in the channel wall 122a close to the covering body 110 in the channel 122. Thus, the inner groove 123 can communicate with the channel 122 and the oil draining hole 130 at the same time. The inner groove 123 can be used as a pressure storage space. When the oil is in the inner groove 123, it can be squeezed by an external force, and after the accumulated pressure, the oil is drained to the oil draining hole 130.

According to FIG. 3, the oil draining hole 130 is an elongated flat hole, which extends radially outward from the inner groove 123 and passes through the covering body 110. The oil draining hole 130 can communicate with the channel 122 through the inner groove 123, so that the oil can be drained from the covering space S1 through the channel 122, the inner groove 123 and the oil draining hole 130. In addition, since the inner bundling ring 121 is made of a hard material, the inner bundling body 120 and the opening S3 can have a lower deformation amount. Therefore, the channel 122, the inner groove 123 and the oil draining hole 130 are all arranged adjacent to the inner bundling ring 121, and the oil draining function is not easily affected by the deformation of the dust boot 100.

It should be noted that, since each type of dust boot has the inner bundling ring, the channel, the inner groove and the oil draining hole can be directly arranged at a position adjacent to the inner bundling ring. The deformation of the position is small, and the oil draining function can be stably provided without reconsidering the structural configuration for each type and size of dust boot.

The dust boot 100 can further include a positioning protruding element 140, the positioning protruding element 140 is disposed at an outside of the covering body 110, and corresponds to the oil draining hole 130. The oil draining hole 130 passes through the positioning protruding element 140. In detail, the positioning protruding element 140 is disposed on the outside of the covering body 110 and adjacent to the first annular edge 111. The position of the positioning protruding element 140 corresponds to the channel 122, the inner groove 123 and the oil draining hole 130. The oil draining hole 130 extends radially toward the inner groove 123, passes through the covering body 110 and the positioning protruding element 140, and a passage is formed by the channel 122, the inner groove 123 and the oil draining hole 130. The oil can be drained from the covering space S1 along the passage.

It should be noted that, though there is only one passage in the 1st embodiment, a plurality of passages can be included in other embodiments, and the oil can be drained from the covering space through the passages, but the present disclosure is not limited thereto.

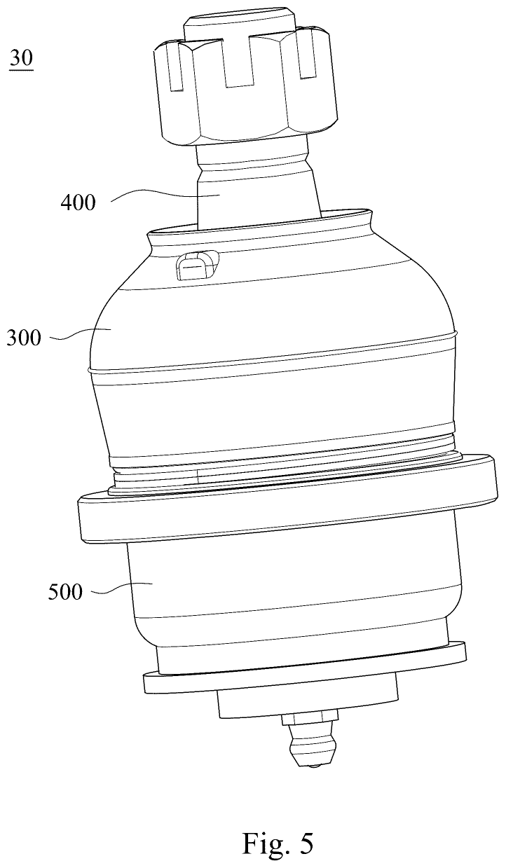

The inner bundling body 120 can include at least one annular convex rib 124, the at least one annular convex rib 124 protrudes from an inner side edge of the inner bundling body 120. The dust boot 100 can be set at a joint between a ball pin (such as the ball pin 400 in FIG. 5) and a ball socket (such as the ball socket 500 in FIG. 5), and each annular convex rib 124 is roughly rib-shaped. Each annular convex rib 124 protrudes radially inward from the inner edge of the inner bundling body 120. When the dust boot 100 is encased on the ball pin, at least one annular convex rib 124 is favorable for increasing the sealing between the dust boot 100 and the ball pin. In the 1st embodiment, a number of the at least one annular convex rib 124 is three. In other embodiments, the number of the annular convex ribs may not be three, and the inner bundling body may not have any annular convex ribs.

The dust boot 100 can further include a lower bundling body 150, the lower bundling body 150 is disposed in the covering body 110 and adjacent to the second annular edge 112, and the lower bundling body 150 protrudes radially outward. The lower bundling body 150 is roughly ring-shaped, and the lower bundling body 150 protrudes radially outward from a side of the covering body 110 adjacent to the second annular edge 112. The lower bundling body 150 includes a lower bundling ring 151, the lower bundling ring 151 is made of a hard material, such as steel, copper, etc. The lower bundling ring 151 is disposed in the lower bundling body 150 to prevent the second annular edge 112 of the covering body 110 from being deformed and causing oil leakage. In detail, the lower bundling ring 151 includes a lower ring portion (its reference numeral is omitted) and a lower bundle portion (its reference numeral is omitted). The lower ring portion extends radially and inwardly upward, and the lower bundle portion extends along the axis. The lower bundle portion protrudes upward from an outer of the lower ring portion. In other embodiments, the lower bundling ring can be other shapes that can prevent the second annular edge of the covering body from being deformed, and can also be disposed on an exterior of the lower bundling body.

The dust boot 100 of the 1st embodiment can be manufactured by using an overmolding process. The material for manufacturing the inner bundling ring 121 and the lower bundling ring 151 can be heated to a molten state. The material is injected into the mold of the inner bundling ring 121 and the mold of the lower bundling ring 151 respectively. After the inner bundling ring 121 and the lower bundling ring 151 are formed, the inner bundling ring 121 and the lower bundling ring 151 are moved to the mold of the dust boot 100, and the material of the dust boot 100 heated to a molten state is injected. After cooling, the dust boot 100 of the present disclosure can be manufactured. The mold of the dust boot 100 can include a detachable mold core, and the detachable mold core is configured to form the inner groove 123. The detachable mold core can eliminate the need for additional processing to form the inner groove 123 so as to save the manufacturing time. In addition, after the dust boot 100 is overmolded, the positioning protruding element 140 can be punctured to form the oil draining hole 130.

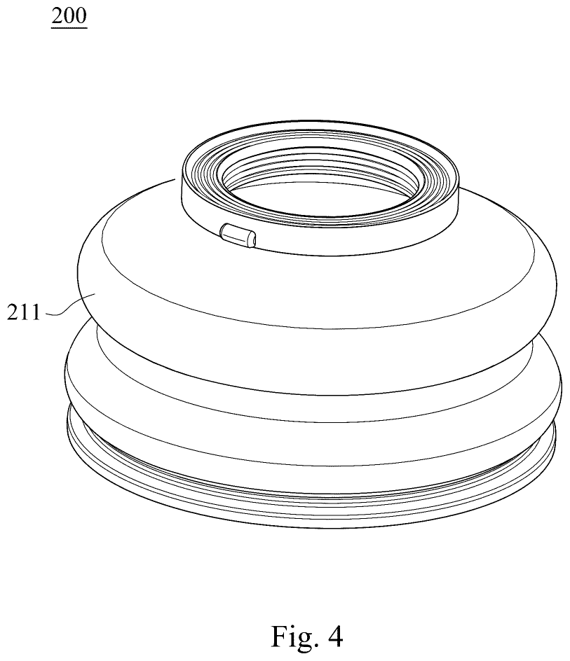

FIG. 4 is a three-dimensional view of a dust boot 200 of the 2nd embodiment of the present disclosure. According to FIG. 4, the dust boot 200 of the 2nd embodiment is similar to the dust boot 100 of the 1st embodiment and includes a covering body (its reference numeral is omitted), an inner bundling body (its reference numeral is omitted), an inner bundling ring (its reference numeral is omitted), a channel (its reference numeral is omitted), an oil draining hole (its reference numeral is omitted) and a positioning protruding element (its reference numeral is omitted). The differences between the dust boot 200 and the dust boot 100 are described below, and the similarities are not described again herein.

The covering body includes at least one protruding ring 211, the at least one protruding ring 211 is favorable for the dust boot 200 to adapt the corresponding deformation caused by a ball pin (such as the ball pin 400 in FIG. 5) and a ball socket (such as the ball socket 500 in FIG. 5) easily.

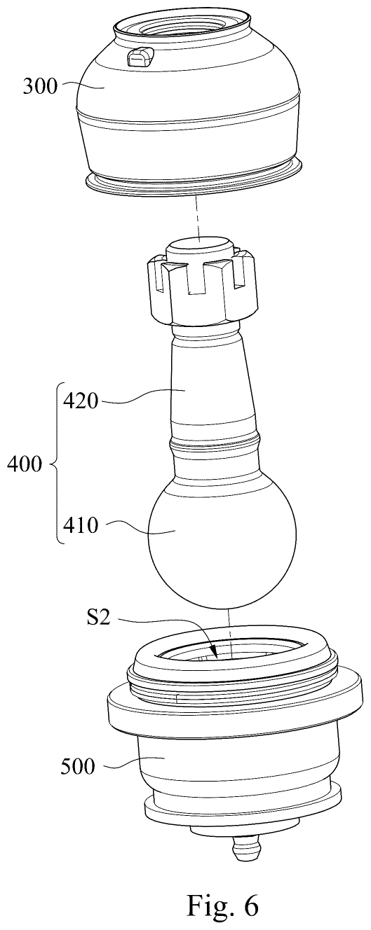

FIG. 5 is a three-dimensional view of a ball joint structure 30 of the 3rd embodiment of the present disclosure. FIG. 6 is an exploded view of the ball joint structure 30 of the 3rd embodiment in FIG. 5. According to FIG. 5 and FIG. 6, the ball joint structure includes a ball socket 500, a ball pin 400 and a dust boot 300. The ball socket 500 includes a ball socket space S2. The ball pin 400 includes a spherical portion 410 and a shafting portion 420. The spherical portion 410 is connected to the shafting portion 420, and when the ball pin 400 is inserted into the ball socket 500, the spherical portion 410 is accommodated in the ball socket space S2. The dust boot 300 encases on the shafting portion 420 and an upper end of the ball socket 500, the dust boot 300 of the 3rd embodiment is similar to the dust boot 100 of the 1st embodiment and includes a covering body (its reference numeral is omitted), an inner bundling body (its reference numeral is omitted), an inner bundling ring (its reference numeral is omitted), a channel (its reference numeral is omitted), an oil draining hole (its reference numeral is omitted) and a positioning protruding element (its reference numeral is omitted). The shafting portion 420 is disposed through the covering space (its reference numeral is omitted) of the covering body, and the upper end of the ball socket 500 is accommodated in the covering space. The inner bundling body is disposed on an opening (its reference numeral is omitted) of the covering body, and abuts against the shafting portion 420, and the similarities are not described again herein.

In detail, the ball socket 500 is roughly cylindrical and includes a ball socket space S2. The ball socket 500 includes an insertion port (its reference numeral is omitted) connected to the ball socket space S2, and the ball pin 400 can be inserted into the ball socket space S2. Moreover, since the dust boot 300 and the ball pin 400 must be pressed downward when assembling the dust boot 300, the ball pin 400 and the ball socket 500, resulting in different deformation amounts of dust boots of different models and sizes. In the 3rd embodiment, the channel adjacent to the inner bundling ring can prevent the oil draining hole from being easily squeezed, and it is favorable for stably providing the oil draining function.

The spherical portion 410 is roughly spherical, and the shafting portion 420 is roughly cylindrical, and an upper end of the spherical portion 410 is connected to a lower end of the shafting portion 420. The shape of the spherical portion 410 can correspond to the ball socket space S2 so as to make the spherical portion 410 accommodated in the ball socket space S2 when the ball pin 400 is inserted into the ball socket 500. After the ball pin 400 is inserted into the ball socket 500, the dust boot 300 can be installed downward from an upper end of the shafting portion 420. The shafting portion 420 passes through the covering space and exits from the opening. The inner bundling body and a second annular edge (its reference numeral is omitted) can encase on the shafting portion 420 and the upper end of the ball socket 500, respectively. The inner bundling body abuts against the shafting portion 420. An inner side of the second annular edge of the covering body contacts an outer side of the upper end of the ball socket 500 so as to make the dust boot 300 cover a joint between the ball socket 500 and the ball pin 400, and it is favorable for preventing moisture or dirt from entering the joint.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A dust boot, comprising:
a covering body, comprising:
a covering space;
a first annular edge; and
a second annular edge being opposite to the first annular edge, wherein a diameter of the second annular edge is greater than a diameter of the first annular edge;
an inner bundling body disposed on the covering body and being adjacent to the first annular edge, the inner bundling body protruding radially toward the covering space;
an inner bundling ring located inside the inner bundling body and covered by the inner bundling body, the inner bundling ring comprising a ring portion and a bundle portion, wherein the bundle portion protrudes downwardly along an axis from an inner edge of the ring portion;
a channel disposed in the inner bundling body and communicating with the covering space, the channel located in a bottom of the ring portion and an outside of the bundle portion; and
an oil draining hole passing through the covering body and communicating with the channel, wherein the oil draining hole allows an oil to drain from the covering space.

2. The dust boot of claim 1, further comprising:
a positioning protruding element disposed at an outside of the covering body, and corresponding to the oil draining hole;
wherein, the oil draining hole passes through the positioning protruding element.

3. The dust boot of claim 1, wherein a channel width of the channel is between 1 mm and 10 mm.

4. The dust boot of claim 1, wherein the inner bundling body further comprises:
an inner groove recessed in a channel wall of the channel, and the inner groove communicating with the channel;
wherein, the oil draining hole passes through the inner groove.

5. The dust boot of claim 1, wherein the oil contacts with the ring portion.

6. The dust boot of claim 1, wherein the inner bundling body comprises at least one annular convex rib protruding from an inner side edge of the inner bundling body.

7. A ball joint structure, comprising:
a ball socket comprising a ball socket space;
a ball pin comprising a spherical portion and a shafting portion, wherein the spherical portion is connected to the shafting portion, and when the ball pin is inserted into the ball socket, the spherical portion is accommodated in the ball socket space; and
a dust boot encasing on the shafting portion and an upper end of the ball socket, the dust boot comprising:
a covering body comprising a covering space, a first annular edge and a second annular edge, wherein the shafting portion is disposed through the covering space, and the upper end of the ball socket is accommodated in the covering space, the second annular edge is opposite to the first annular edge, a diameter of the second annular edge is greater than a diameter of the first annular edge;
an inner bundling body disposed on the covering body, being adjacent to the first annular edge and abutting against the shafting portion, the inner bundling body protruding radially toward the covering space;
an inner bundling ring located inside the inner bundling body and covered by the inner bundling body, the inner bundling ring comprising a ring portion and a bundle portion, wherein the bundle portion protrudes downwardly along an axis from an inner edge of the ring portion;
a channel disposed in the inner bundling body and communicating with the covering space, the channel located in a bottom of the ring portion and an outside of the bundle portion; and
an oil draining hole passing through the covering body and communicating with the channel, wherein the oil draining hole allows an oil to drain from the covering space.

8. The ball joint structure of claim 7, wherein the dust boot further comprises:
a positioning protruding element disposed at an outside of the covering body, and corresponding to the oil draining hole;
wherein, the oil draining hole passes through the positioning protruding element.

9. The ball joint structure of claim 7, wherein a channel width of the channel is between 1 mm and 10 mm.

10. The ball joint structure of claim 7, wherein the inner bundling body further comprises:
an inner groove recessed in a channel wall of the channel, and the inner groove communicating with the channel;
wherein, the oil draining hole passes through the inner groove.
